(19) United States
(12) Patent Application Publication
(10) Pub. No.: US 2006/0097469 A1
(43) Pub. Date: May 11, 2006

(54) Composite board and process for making the board

(76) Inventors: Ross Mervyn Nosworthy, Wurtulla (AU); Jennifer Joyce Mitchell, Wurtulla (AU)

Correspondence Address: LADAS & PARRY, 26 WEST 61ST STREET, NEW YORK, NY, 10023, US

(21) Appl. No.: 10/517,498

(22) PCT Filed: Jun. 10, 2003
(86) PCT No.: PCT/AU03/00722

§ 371 Date: Jul. 25, 2005

(30) Foreign Application Priority Data
Jun. 11, 2002 (AU) PS 2894

(51) Int. Cl. B62M 1/00

(52) U.S. Cl. 280/87.042

(57) ABSTRACT

This invention relates to a composite board including: a core having upper and lower surfaces and at least one aperture extending therebetween, at cast one upper reinforcing layer disposed on the upper surface of the core and at least one lower reinforcing layer disposed on the lower surface of the core, the upper and lower reinforcing layers each including at least one aperture extending therethrough, the apertures in the upper and lower reinforcing layers being in substantial alignment with each other and with the aperture or apertures in the core, at least one tie member passing through the substantially aligned apertures, each said tie member having a first end portion protruding through said aligned apertures from said upper reinforcing layer and a second end portion protruding through said aligned apertures from a said lower reinforcing layer, said first and second end portions being secured to a surface of said respective lyaers. A process for preparing the composite board and a skateboard deck formed from the composite board are also disclosed.

### TECHNICAL FIELD

The present invention relates to a composite board and a process for making the board. In one embodiment the present invention relates to a composite board suitable for use as a skateboard deck.

### BACKGROUND OF THE INVENTION

A skateboard deck provides a flat standing surface of a skateboard. Present skateboard decks are typically made from a number of plies of maple veneer, which are laminated, cut, drilled, sanded and lacquered. Such skateboard decks suffer from the disadvantage that they have limited “pop”. “Pop” is a term used to describe the amount of spring or recoil of a board which allows a rider to jump (ollie) higher into the air from a flat or level surface when stationary or when moving. An ollie is achieved by the rider simultaneously jumping and kicking the tail of the board into the ground causing the board to “pop” by bouncing the board into the air. Maple board manufacturers have continually attempted to improve the “pop” of their boards with limited success. Maple boards also tend to delaminate or fail when wet, are typically noisy and rough to ride and the surface finish/graphic is easily scratched and difficult if not impossible to restore.

The provision of a composite board having good spring or recoil and which is not easily delaminated would be desirable in a number of applications including but not limited to skateboards, waterskis, snowboards and skis.

### OBJECT OF THE INVENTION

It is the object of the present invention to overcome or substantially ameliorate at least one of the above disadvantages.

### SUMMARY OF THE INVENTION

According to a first aspect, the present invention consists in a composite board including:

a core having upper and lower surfaces and at least one aperture extending therebetween,

at least one upper reinforcing layer disposed on the upper surface of the core and at least one lower reinforcing layer disposed on the lower surface of the core, the upper and lower reinforcing layers each including at least one aperture extending therethrough, the apertures in the upper and lower reinforcing layers being in substantial alignment with each other and with the aperture or apertures in the core,

at least one tie member passing through the substantially aligned apertures, each said tie member having a first end portion protruding through said aligned apertures from said upper reinforcing layer and a second end portion protruding through said aligned apertures from said lower reinforcing layer, said first and second end portions being secured to a surface of said respective layers.

According to a second aspect, the present invention consists in a process for preparing a composite board including

placing into a mold a core having upper and lower surfaces and at least one aperture extending therebetween, positioning at least one upper reinforcing layer on the upper surface of the core and at least one lower reinforcing layer on the lower surface of the core, the upper and lower reinforcing layers each including at least one aperture extending therethrough, the apertures in the upper and lower reinforcing layers being in substantial alignment with each other and with the aperture or apertures in the core, passing at least one tie member through the substantially aligned apertures, each said tie member having a first end portion protruding through said aligned apertures from said upper reinforcing layer and a second end portion protruding through said aligned apertures from said lower reinforcing layer, and securing said first and second end portions to a surface of said upper and lower layers, respectively;

filling the mold with resin and

allowing the resin to cure.

According to a third aspect, the present invention consists in a skateboard having

a deck formed from the composite board according to the first aspect.

There is disclosed herein a composite board including:

a core having at least one aperture and upper and lower surfaces, at least one upper reinforcing layer on the upper surface of the core and at least one lower reinforcing layer on the lower surface of the core, the upper and lower reinforcing layers including at least one aperture, the apertures in the upper and lower reinforcing layers being in substantial alignment with each other and with the aperture or apertures in the core,

at least one tie member passing through the substantially aligned apertures, and having first and second portions protruding through said aligned apertures, said first and second portions being secured to a surface of said respective layers, the tie member thereby tying the upper and lower reinforcing layers to the core.

There is disclosed herein in a process for preparing a composite board including:

placing into a mold a core having at least one aperture and upper and lower surfaces, positioning at least one upper reinforcing layer on the upper surface of the core and at least one lower reinforcing layer on the lower surface of the core, the upper and lower reinforcing layers including at least one aperture, the apertures in the upper and lower reinforcing layers being in substantial alignment with each other and with the aperture in the core, passing at least one tie member having first and second ends through the substantially aligned apertures, and securing said first and second ends to a surface of said upper and lower layers, respectively;

filling the mold with resin and

allowing the resin to cure.

Additional reinforcing layers may also be present on either side of the upper and lower reinforcing layers. If desired, the additional layers may also be provided with at least one aligned aperture for accommodating the at least one tie member.

Each layer need not be coextensive with another. Layers may be formed from two or more separate pieces. Suitably each layer is rectangular in shape but it may have rounded ends. In certain embodiments an indented semicircular region at each end of a layer, which can be folded about other layers placed on the same side of the core, may be provided. Notches may be provided in the semicircular regions so as to eliminate gathering or folding.

The aperture may be in the form of a hole, a slit or a slot. Suitably the board is for use in a skateboard deck and one or more aligned slots are suitably provided in at least one or more of the front end of the deck, the tail end of the deck or centrally in the board and extending along a portion of its length and/or width.

The width of the tie member suitably approximates the width of the aligned apertures so that it fits snugly in the aligned apertures. It is possible however that the width of the tie member may be less than the width of the aligned apertures. The tie member is suitably formed from a material capable of being folded over an upper and lower edge of the aligned apertures of the upper and lower reinforcing layers without breaking. Alternatively, the tie member can be preformed into a suitable configuration so that it can be passed through the aligned apertures and clipped into place. Suitable configurations would include a C-shape or zig-zagged configuration. Suitably the tie member is formed from fibreglass, suitably a triaxial fibreglass. Other suitable materials for forming the tie member include metal wire, metal wire mesh or a preformed polycarbonate tie member. One tie member may be present in an aligned aperture, but more suitably a pair of tie members is present in at least one, suitably all aligned apertures. The ends of each tie member that protrude through the aperture can be folded over edges of the aligned apertures of the upper and lower reinforcing layers in the same direction as each other or in opposed directions with respect to either the length or width of the board. As an alternative, the first and second ends of the tie member can include one or more cuts along their width so as to enable the same end to be folded about edges of the aperture in various directions. It is within the scope of this invention for the tie member(s) to be preformed in similar configurations.

The ends of the tie member can be secured to the surfaces of the upper and lower reinforcing layers by any suitable securing means such as by stapling, by use of an adhesive, by use of a fastening system such as a nail, screw, bolt or pin or by soldering or welding. One or more reinforcing pieces, suitably of unidirectional R glass with its fibres suitably oriented at 90° or at another angle between about 10 and 90° with respect to the major dimension of the board and above and below the aligned apertures and, if the board is used for a skateboard deck, above and below truck mounting points, may be provided for additional strength.

Suitably the composite board is impregnated with a resin. Typically the resin is a thermosetting resin, more typically an epoxy or polyester resin, still more typically a polyester resin. Other suitable resins include a polyurethane resin.

The core is typically chosen so as to be lightweight. Typically the core is made from foam, suitably a vinyl sheet or a polyurethane foam, more typically a cross-linked polyvinylchloride (PVC) foam such as Klegecell™ foam or Divinycell™ foam core such as Klegecell™ R75 or Divinycell™ H80 (Trademarks of Diabgroup). Nomex honeycomb can also be used but would typically need to be preformed and sealed either side to substantially prevent the honeycomb filling with resin. In addition wood such as end-grain balsa can also be used but also would typically need to be preformed in layers similar to ply and glued together.

Klegecell™ R75 is a regular temperature crosslinked PVC foam core made by Diabgroup and available from Fibreglass International Pty Ltd (Brisbane) and has a density of 75 kg/m³, a compression strength of 1.1 MPa, a compression modulus of 85 MPa, a tensile strength of 2.0 MPa, a shear strength of 0.9 MPa and a shear modulus of 29 MPa. Divinycell™ H80 is also made by Diabgroup and available from Synthetic Resins Brisbane and is a regular temperature crosslinked PVC foam core having a density of 80 kg/m³, a compression strength of 1.2 MPa, a compression modulus of 85 MPa, a tensile strength of 2.2 MPa, a tensile modulus of 80 MPa, a shear strength of 1.0 MPa and a shear modulus of 31 MPa. Other suitable Eegecell™ foams include Klegecell™ R100 a regular temperature crosslinked PVC foam having density of 100 kg/m³, a compression strength of 1.7 MPa, a compression modulus of 125 MPa, a tensile strength of 3.1 MPa, a shear strength of 1.4 MPa, and a shear modulus of 40 MPa; Klegecell™ TR75 a high temperature crosslinked PVC foam core having a density of 75 kg/m³, a compression strength of 1.1 MPa, a compression modulus of 47 MPa, a tensile strength of 1.4 MPa, a shear strength of 0.9 MPa and a shear modulus of 24 MPa; and Klegecell™ TR100 a high temperature crosslinked PVC foam core having a density of 100 kg/m³, a compression strength of 1.6 MPa, a compression modulus of 65 MPa, a tensile strength of 2.1 MPa, a shear strength of 1.3 MPa and a shear modulus of 33 MPa Klegecell™ R75 is more typically used as it is easier to heat form.

Other suitable core materials include polycarbonate, aluminium honeycomb, metallic and/or plastic tubes or polyurethane foam. The core may include fibre reinforcement. The core may be provided with grooves suitably longitudinally extending along the length of the core to assist the flow of resin.

The core has one or more reinforcing layers on each of its upper and lower surfaces. Suitably each layer is of a non-woven material, and is suitably biaxial or unidirectional. Suitably at least one layer on each side of the core is a unidirectional layer. The layers are suitably chosen such that one layer is capable of being stretched when the other layer is compressed. Typically at least two layers are present on either side of the core. When at least two layers are used, suitably at least one layer is unidirectional and another is biaxial. Suitably each layer is formed from a fibrous material such as fibreglass, typically E-glass, R-glass, Te-glass or S-glass. E-glass is a regular grade of glass fibre, which has been available since the 1940s, is inexpensive and used commonly. E-glass has a high fibre strength (˜500 Ksi) and a relatively low fibre modulus (˜10.5 Msi). Owens Corning report an E-glass/epoxy tensile modulus of 6.5 Msi. A suitable E-glass for use in the present invention is 0-90 biaxial E-glass made by Colan (Sydney) and available from Fibreglass International Pty Ltd (Brisbane). This glass is biaxial having two sets of straight strands running perpendicularly. Unidirectional E-glass can also be used. R-glass, S-glass and Te-glass are high grades of glass fibre and are stronger than E-glass having a higher fibre strength of ˜600 Ksi and a higher modulus (˜12.5 Msi). Owens Corning report an S-2 glass fibre/epoxy tensile modulus of 9.2 Msi. A suitable R-glass is unidirectional R glass made by Hexcel Texas and available from Fibreglass International Pty Ltd. This glass is unidirectional having strands running in one direction and has good impact strength contributing to the spring of the composite.

Suitably at least two layers are provided on each surface of the core. Suitably one layer is a biaxial layer and another layer is a unidirectional layer. In one embodiment a first layer suitably adjacent the core is typically formed from E-glass, suitably biaxial E-glass and a second layer suitably adjacent the first layer is typically being formed from S-glass, R-glass or Te-glass, more suitably R-glass, even more suitably unidirectional R-glass. In a further embodiment three layers are on each side of the core, a first layer adjacent the core being formed from R-glass (suitably unidirectional), a second layer adjacent the first layer being formed from E-glass (suitably biaxial) and a third layer adjacent the second layer being formed from R-glass (suitably unidirectional).

The layers are suitably chosen so that the number of layers on the top side of the core is equal to the number of layers on the bottom side creating opposing layers such that when one layer is stretched the other becomes compressed thereby improving strength.

Other suitable materials which can be used in the present invention for forming the upper and lower reinforcing layers include aramid (Kevlarf) and carbon (graphite) including unidirectional carbon and unidirectional aramid. Carbon typically has a higher tensile modulus than glass. Owens Corning report a carbon/epoxy tensile modulus of 19 Msi. In addition reinforcing layers can be formed from wood, metal, polycarbonate, styrene or polyamides.

For additional strength strips of fibreglass tape can be provided on the outer edge or perimeter of the composite board. Suitably the tape is woven, typically a biaxially or triaxially woven tape. E-glass biaxial or triaxial tape is more typically used, triaxial E-glass being preferred. Use of tape around the perimeter of the board prevents the board splitting along the sides thereby resisting damage.

The resin used in the production of the composite board of the invention is suitably a polyester, epoxy or vinyl ester resin. When fibreglass is used for the upper and lower layers, a polyester resin is suitably used. When carbon (graphite) or aramid is used, the resin is suitably a vinyl ester or epoxy resin. Suitably the resin is a polyester waxfree resin. In tests conducted by the Applicant, a fibreglass board made using polyester resin is typically stronger than a similar board having identical layup using a vinyl ester resin. One suitable resin is Polylite GP Waxfree Lam 25 (code F61340-30), a polyester resin manufactured by Nuplex resins under licence from Reichold U.S.A. and available from Fibreglass International Pty Ltd (Brisbane). Any suitable catalyst can be used including MEKP catalysts such as MEKP NR (normal reaction) and NEKP SR (slow reaction). One suitable catalyst is MEKP NR Butanox manufactured by AKZO Nobel and available from Synthetic Resins (Brisbane). Suitably the molding is performed at room temperature and at pressures of about 12 psi (82 kPa), although higher or lower temperatures and pressures can be used.

By using a mold, a joinless composite board can be prepared having good strength. The composite board can be used to form a deck of a skateboard. The underside of deck of such a skateboard is suitably provided with fore and aft trucks secured to the deck toward and spaced away from end of the deck, each truck being provided with an axle, the axle carrying at least one wheel. Skateboards produced from the board of the invention have good resiliency, strength and elasticity and are not easily delaminated. Skateboards made from the composite board of the invention have a significant increase in “pop” as compared with maple boards. In addition the skateboard is not affected by wet weather, is smoother and quieter to ride and the surface finish/graphic of the board suitably applied by means of a gelcoat can be restored by a simple cut and polish. Skateboards made from the composite of the invention are typically the same or lighter in weight than present maple boards.

The fibre-reinforced composite board of the invention is not limited to use as skateboard decks but can also be used in other applications such as waterskis, skis, snowboards, wake skates and skim boards.

### BRIEF DESCRIPTION OF THE DRAWINGS

A preferred form of the present invention will now be described by way of example with reference to the accompanying drawings wherein:

FIG. 1 is a drawing showing various components of a skateboard deck according to one embodiment of the invention;

FIG. 2 is a drawing showing in a front view how the various components of a skateboard deck according to the embodiment of FIG. 1 fit together to form a composite board; and

FIG. 3 is a cross-sectional view of the skateboard deck of the embodiment of the invention shown in FIG. 1 as prepared.

### DETAILED DESCRIPTION OF THE PREFERRED EMBODIMENTS

The composite board described in the following suitably forms a deck of a skateboard, the deck forming a platform for supporting the rider with the underside of the deck being provided with fore and aft trucks secured to the deck toward and spaced away from the ends of the deck and which enable the rider to direct the skateboard. Each truck suitably has an axle fixed therein, the skateboard wheels being carried on distal portions of the truck axle, the wheels carrying bearings and which rotate about the axle. The truck suitably provides for tilting movement of the axle about a mounting axis.

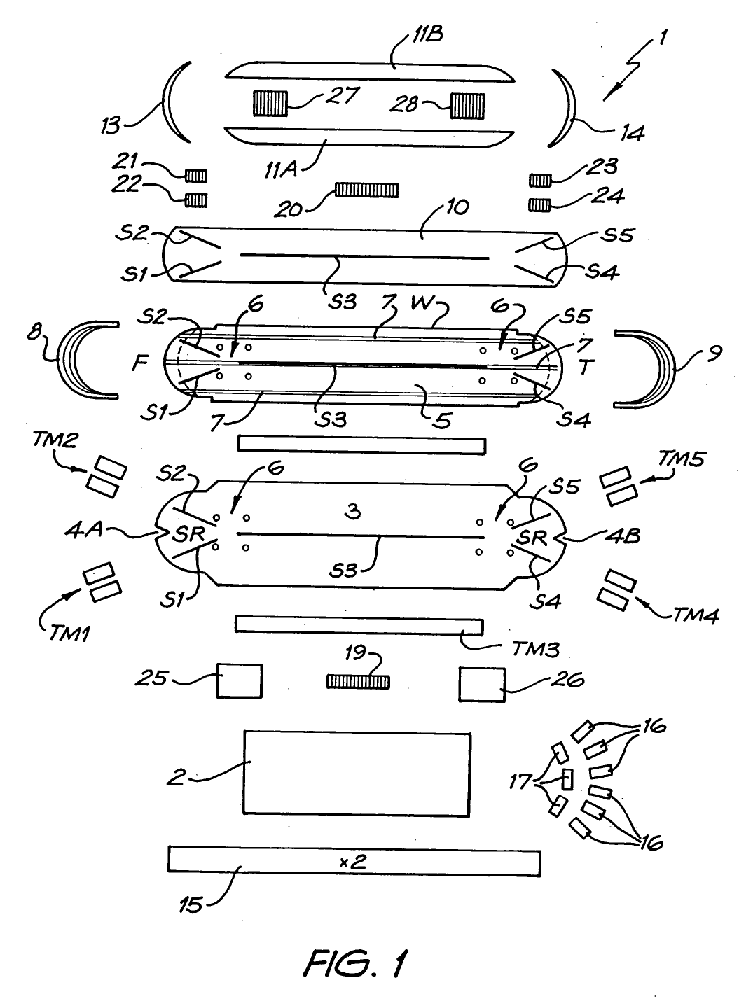

Referring to FIGS. 1 to 3, which are not drawn to scale, various components of a skateboard deck 1 having a front end F and a tail end T in accordance with a preferred embodiment are shown. The skateboard deck 1 includes a first bottom layer 2 forming the bottom surface of the deck 1 and which is suitably formed from 280 grain unidirectional R-glass manufactured by Hexcel-Texas and available from Fibreglass International Pty Ltd in a 300 mm wide roll. All unidirectional glass is suitably placed so that it runs from front end F to tail end T unless otherwise stated. The first bottom layer 2 suitably has a length of 410 mm and a width of 170 mm and is rectangular in shape. First bottom layer 2 suitably functions so as to provide strength recoil and stiffness and impact resistance on the bottom side of the deck 1 and contributes to the strength and “pop” of the deck 1.

Above the first bottom layer 2, a second bottom layer 3 is provided which is suitably 887 gram biaxial E glass 0°-90° or 566 gram biaxial E glass 0° to 90°, both manufactured by Colan-Sydney and available from Fibreglass International Pty Ltd. Second bottom layer 3 provides the main strength for the skateboard deck 1. 566 gram biaxial E glass is used to make lightweight boards (up to 10% or more lighter in weight) and longer, wider vert ramp (half pipe) boards. Another suitable glass which could be used is 650 gram biaxial E glass or 600 gram biaxial E glass. The second bottom layer 3 is shaped to include a middle rectangular region and an indented semicircular region SR at both of its front and tail ends so that it can be wrapped around the edge of subsequent layers. Second bottom layer 3 suitably has a length of 860 mm and a width of 300 mm. Second bottom layer 3 is suitably provided with notches 4A and 4B at the each end so as to minimise or eliminate gathering when it is pulled around the end of a core 5 during wrapping. The notches 4A and 4B suitably have a width of 30 mm and a depth of 45 mm. The second bottom layer 3 is also provided with slots S1, S2, S3, S4 and S5, which are respectively provided so as to accommodate pairs of tie members TM1, TM2, TM3, TM4 and TM5 through their thickness. Slot S3 extends longitudinally along the length of the layer but is shorter than the total length of the layer 3 and is located centrally in the middle rectangular region, whereas slots S1, S2 and S4 and S5 are disposed centrally within the semicircular region SR at an angle (suitably a 45° angle) to slot S3. The tie members TM1, TM2, TM3, TM4 and TM5 which are passed through the slots S1, S2, S3, S4 and S5 respectively are used to tie the upper and lower layers of the skateboard deck 1 together suitably by folding an upper and lower end of each tie member TM1, TM2, TM3, TM4 and TM5 over the upper and lower layers and respectively securing the upper and lower ends to a surface of the upper and lower layers thereby increasing strength, the centre spine tie member TM3 also resisting impact dents. If enough force is created in a bad landing on the kick, opposing forces on the layers could sheer the core material after which the layers could move away from one another thereby weakening the deck. The tie members serve to overcome this problem. The pair of tie members TM3 are suitably rectangular in shape and suitably measure from 375 to 395 mm long (depending on board design) and 55 mm wide, while tie members TM1, TM2, TM4 and TM5 are suitably rectangular in shape and 110 mm in length and 55 mm wide. The tie members are suitably formed from 750 gram triaxial weave (0+/−45 degree) E glass available from ATL Composites of 27 Gibbs Street Labrador, Qld, 4215. The slots in the layer 3 closely match in length to the length of the tie members such that the tie members fit snugly in the slots when they are passed through the thickness of the slots. The slots are suitably about 2.5 mm wide so as to suitably snugly accommodate the thickness of each pair of tie members. The slots S1, S2, S3, S4 and S5 suitably start about 10 mm inside the truck mounting bolt patterns 6 although in an alternate embodiment slot S3 can extend across the truck mounting bolt patterns into the semicircular region SR.

A core 5 forms the middle of the skateboard deck 1 and is suitably made from Klegecell™ TR75 (8 mm thickness), although it is possible that the core is made from the same material (Klegecell™ TR75) or similar but formed in a closed mold from a liquid. Suitable dimensions for the core are a length of 780 mm and a width of 185 mm at a tail end T and a width of 190 mm at a front end F, with a widest width of 193 mm between the front and tail end at W. These dimensions can be varied as required. For example a 9 mm or thicker core can be used.

The core 5 is suitably heat formed to the desired shape and is suitably provided with grooves 7 along its length to assist correct resin flow during manufacture. Suitably the grooves 7 are 13 mm wide and 1.0 mm deep and end 25 mm from the tail end T of the skateboard deck 1. Suitably at least three grooves are present. The grooves may be present on the top, bottom, upper and/or lower sides. When no grooves or different types of grooves are used, the resulting deck may contain voids or dry patches of glass. Apertures (truck mounting points) 6 are also provided in the core 5 and function as solid points in the deck 1 for trucks (wheels) to be bolted. The core 5 suitably functions to provide lightness to the deck 1 and to separate the skateboard deck 1 into upper and lower portions whilst tying them together by means of the tie members TM1, TM2, TM3, TM4 and TM5 creating opposing layers thereby improving strength. Similarly to the second bottom layer 3, the core 5 is provided with slots S1, S2, S3, S4 and S5 to respectively accommodate the pairs of tie members TM1, TM2, TM3, TM4 and TM5. Similarly to bottom layer 3, the core 5 is provided with an indented semi-circular region SR at its front and tail ends and a central rectangular region. The indented semi-circular region accommodates front and tail inserts 8 and 9. The inserts 8 and 9, which are semicircular in shape to match the semi-circular region SR in the core 5 serve two major purposes. One as an impact protector for the ends of the deck 1 and two as an area that can be worn away without affecting the properties of the deck 1. Suitably the inserts 8 and 9 are formed from casting a two-part thermoset polyurethane (rigid unfilled casting polyurethane TC 880) having a shore hardness of 78D and available from Bames Products, 6 Homedale Road, Bankstown, NSW 2200, Australia and manufactured by BJB Enterprises Incorporated 14791 Franklin Avenue, Trustin, C.A., USA 92780. This material is chosen because of its adhesion properties when encapsulated within the deck 1, its wear capabilities which produces a clean surface as it is ground down and also its impact strength which can be increased by the addition of E-glass or aramid rovings. E glass rovings are available from Fibreglass International, 20 Production Avenue, Wacol, Qld 4076, Australia. Aramid or Kevlar™ is manufactured by DuPont.

The inserts 8 and 9 are formed by placing the material into a mold having the desired shape (radially from end to end of the insert), closing the mold then mixing and pouring the polyurethane into the mold until full and then curing, removal from the mold and post curing in an oven at between 66° C. to 79° C. for 4 to 6 hours.

Even after considerable wear, the inserts 8 and 9 retain excellent impact strength. In comparison, maple boards splinter and delaminate and do not wear smoothly.

On top of core 5 a first upper layer 10 is provided and is suitably formed from 887 gram biaxial 0-90 E-glass or 566 gram biaxial 0-90 E-glass (for lightweight or longer, wider vert ramp boards) and acts as an opposing layer to bottom layer 3. As with bottom layer 3, other glass weights could also be used including 600 g or 650 g biaxial E-glass. First upper layer 10 suitably has a length of 775 mm and a width of 135 mm and is also provided with slots S1, S2, S3, S4 and S5 to respectively accommodate the pairs of tie members TM1, TM2, TM3, TM4 and TM5. The upper layer is suitably rectangular in shape with the ends of the upper layer 10 suitably rounded as shown.

Above first upper layer 10, two pieces 11A and 11B forming a second upper layer are provided and function to oppose first bottom layer 2. The two pieces similarly to firt bottom layer 2 are suitably formed from 280 unidirectional R-glass and suitably have a length of 680 mm and a width of 55 mm. The two pieces are positioned on the topside of the deck 1 down each rail and are used to create the “pop” or spring and stiffness of the skateboard deck 1. The width of the pieces 11A and 11B can be varied to create more or less pop and stiffness. Pieces 11A and 11B are suitable rectangular in shape with half semi-circular ends to match the semicircular ends of the lower layers. R glass is a good strength creator with good impact resistance. Topside semicircular inserts 13 and 14, which are suitably 1 mm fibrecore available from Fibreglass International are also provided to fit as a filler in front and tail inserts 8 and 9 resisting topside wear and improving finish.

In addition two rectangular strips 15 of 750 triaxial (0 degrees+45 degrees) E glass (55 mm wide and 630 mm long) available from ATL Composites are provided along the outside of each side of the skateboard deck 1 so as to provide the major strength for the outer edge and perimeter of the deck 1. Although biaxial E glass can be used, triaxial E glass is preferred to biaxial E glass because it provides better strength to the edge and because of its weave, produces better damage resistance. Six rectangular strips 16 110 mm long of 50 mm wide 200 gram woven tape are also provided around each end of the deck 1 in a fan style pattern such that the strips overlap each other and the side strips 15. A further six rectangular strips 17 are also provided longitudinally as shown all of which overlap. The total number of strips 16 and 17 at each end of the deck 1 being nine (eighteen in total).

In additional one or more pieces 19, 20, 21, 22, 23, 24, 25, 26, 27 or 28 of 280 gram unidirectional R glass are optionally provided and can be rectangular or square in shape as shown. Optional pieces 19 and 20 are suitably 70 mm×80 mm in size and placed with their fibre orientation at 90 degrees to the other layers of unidirectional and about the centre tie member TM3 so as to prevent appearance of a hairline crack down the tie member TM3. Optional pieces 21, 22, 23 and 24 serve a similar purpose and are placed with their fibres oriented the same way as pieces 19 and 20. Optional pieces 21, 22, 23 and 24 are suitably 40 mm×40 mm in size. Optional pieces 25 and 26 are positioned under the aperture points 6 for the trucks, starting inward of the outer bolts and extending past the inner edge of the truck by approximately 25 mm and serve to prevent the board from breaking at the edge of the trucks. Pieces 25 and 26 are suitably 80 mm by 80 mm in size. Optional pieces 27 and 28 with the fibres oriented 90 degrees to the centre are also provided and positioned over the aperture points 6 for the trucks.

The total thickness of the upper layers above the core is suitably 1-2 mm, more suitably 1-1.2 mm. The total thickness of the low layers below the core is suitably 1-2 mm, more suitably 1-1.2 mm.

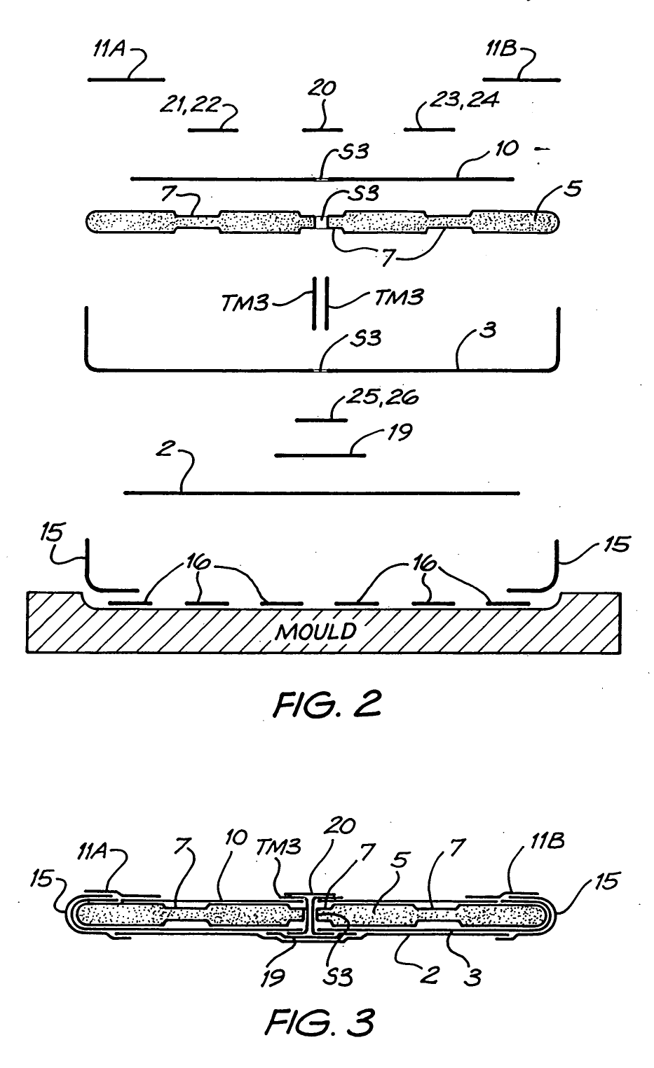

To prepare the skateboard deck 1 a closed mold technique using a lightweight mold can be used (see FIG. 2). In the closed mold technique, an upper and lower mold are provided having a resin inlet and a vacuum outlet. The mold can be gelcoated with a desired colour or effect. The lower half of the mold is packed with each layer in sequence. First the six fan like strips 16 are placed at each end (front and tail) followed by the three longitudinal strips 17. Next the two strips 15 are placed along each edge (rail) overlapping strips 16 evenly on each end. The eighteen strips 16 and 17, and the two strips 15 are positioned so that when they are wrapped over with layer 3 they end up 50/50 top to bottom ie. 50% of the two strips 15 are on the topside and 50% are on the bottom side (suitably 27.5 mm on top and 27.5 mm on the bottom), likewise 55 mm of the fanstyle strips 16 are on top and 55 mm of fanstyle strips 16 are on the bottom.

Once the strips 16, 17 and 15 are in place, first bottom layer 2 is positioned centrally from side to side to overlap strips 15. Layer 2 is also positioned evenly between truck mounting points. Pieces 19, 25 and 26 are then placed on top as shown. The nose and tail inserts 8 and 9 are then positioned at their respective ends.

Next the two centre tie members TM3 and the pairs of nose and kick and tail tie members TM1, TM2, TM4 and TM5 are inserted through their respective slots S3, S1, S2, S4 and S5 in the central core 5. The two tie members TM3 and the pairs of tie members TM1, TM2, TM4 and TM5 are also positioned 50/50 top to bottom.

The central core 5 is then supported upside down and the second bottom layer 3 is placed over the bottom side of the central core 5. Each tie member pair TM1, TM2, TM3, TM4 and TM5 are then fed through the respective slots S1, S2, S3, S4 and S5 provided in the second bottom layer 3, and a tie member of each pair is then folded over at 90° and the other tie member of each pair is folded over at 90° in the opposite direction and the ends of the tie members are then stapled down through the second bottom layer 3 and into the central core 5. The central core 5 with the second bottom layer and tie members is then turned over and placed into the mold. Then the sides of second bottom layer 3 and the upper 50% of strips 15 are firmly folded over the core 5 and stapled down, after which the radial end of second bottom layer 3 with gussets 4A and 4B are folded over the central core 5 and the eighteen radial strips 16 and 17 are folded around and over the respective inserts 8 and 9 and stapled into the central core 5.

After stapling, first upper layer 10 is positioned by feeding the upper 50% of the pair of spine tie members TM3 and the pairs of tie members TM1, TM2, TM4 and TM5 through the respective slots S3, S1, S2, S4 and S5 provided in the first upper layer 10. The upper 50% of the pairs of tie members TM1, TM2, TM3, TM4 and TM5 is then pulled tight and folded over at 90° in opposing directions and their ends stapled down through first upper layer 10 and into the central core 5. First upper layer 10 fills the gaps between the folded over second bottom layer 3. Although it does slightly overlap second bottom layer 3 on the edges, it completely covers second bottom layer 3 on the ends.

After stapling first upper layer 10 and tie members TM1, TM2, TM3, TM4 and TM5, pieces 20, 21, 22, 23 and 24 are positioned over their respective tie members followed by the two strips 11A and 11B of second upper layer down each side edge, which effectively position them on top of the two folded over strips 15. Then the two pieces 27 and 28 are placed over the mounting points for the trucks.

Each end then has the pieces 12 and 13 positioned over the folded strips 16 and 17.

Once the layers have been packed and stapled into position the top side of the mold is then positioned and bolted down to seal the mold. The mold is then evacuated using a pump connected to the vacuum outlet of the mold. The mold is vacuumed down to near full vacuum (30 inches (101 kPa)). Polylite GR Waxfree Lam 25 polyester resin (made by Nuplex Resins under licence from Reichold USA and available from Fibreglass International Pty Ltd (Brisbane)) together with MEKP NR Butanox catalyst (made by AKZO Nobel and available from Synthetic Resins (Brisbane)) are then injected at 12 psi pressure into the resin inlet to fill the mold cavity. A small amount of resin is allowed to exit the vacuum outlet of the mold and then the vacuum outlet is closed off. Pressure is maintained at the inlet and resin continues to fill until a desired amount of resin has entered the mold cavity and the mold cavity is over full. At this stage the mold cavity is under pressure, which facilitates good wetout. The vacuum outlet is then opened to the atmosphere after which the resin inlet is closed, the mold is then allowed to depressurise and excess resin is allowed to drain. The mold is then left to cure.

The dimensions of the board as given above will vary with different board designs and sizes. For example additional layers may be provided such as additional unidirectional layers between the biaxial layers 3 and 10 and the core 5. These additional unidirectional layers may be formed of a single piece of unidirectional R-glass and similarly to layer 10, be provided with rounded ends or formed from two or more separate pieces of fibreglass. In addition one or more of the layers may be shaped and sized so that it can be wrapped over subsequent layers. Different fibreglass weights can be substituted for those already disclosed. For example 450 to 900 gram biaxial glass can be used. The weight of unidirectional glass which can be used is typically in the range of 100-500 grams. For example, S-unidirectional glass can be used in the following weights of 160 gram, 200 gram, 275 gram and 500 gram. R-unidirectional glass can be used in 165 gram, 160 gram and 280 gram weight and SR-unidirectional glass can be used in 300 gram weight. Alternatively unidirectional and biaxial carbon layers can be substituted for one or more of the fibreglass layers. Epoxy resin can be substituted for the polyester resin.

One such alternate board could include a first bottom layer having a length of 795 mm and a width of 308 mm and rectangularly shaped but including an indented semicircular region similar to that described previously so that it can be wrapped around the edge of subsequent layers of the deck so as to hold the subsequent layers in position and then stapled to the edge of the core. A second rectangular bottom layer 3 could then suitably have a length of 870 mm and a width of 280 mm with notches as above and rounded ends. A third rectangular bottom layer with rounded ends could also be provided which similarly to the bottom layer 2 could be made from 280 gram unidirectional R-glass. This third bottom layer could be left out but would suitably be provided to protect the bottom of the board from impact dents and hence failure. Third bottom layer 5 need not cover the fall width of the deck but only cover that area subject to impact dents and could have a length of 783 mm and a width of 130 mm. A rectangular core with rounded ends would then be provided having longitudinally extending grooves and apertures for the trucks. On the upper side of the core a first upper layer could be provided and suitably formed from 280 gram unidirectional R-glass as two separate front and tail pieces. This first upper layer could be left out but would suitably be provided to balance layup of the third bottom layer with the two pieces being positioned over the kick (turn up) area at each end of the deck. Quite often a skateboard will break at the turn up of the kick just in front of the trucks whilst performing ollies. The two pieces of this first upper layer would suitably have a width of 130 mm a first piece would be towards the front of the skateboard deck suitably having a length of 190 mm and a second piece towards the tail of the skateboard deck would suitably having a length of 175 mm. The two pieces would suitably be rectangular in shape with rounded ends to match the lower layers. A rectangular second upper layer suitably of biaxial E-glass would then be provided on top of the first upper layer and have a length of 750 mm and a width of 130 mm with rounded ends. Above second upper layer, two rectangular pieces could be provided which are suitably formed from 280 gram unidirectional R-glass and similar to pieces 27 and 28 of skateboard deck 1. These pieces would be fitted at 90 degrees to the other layers of unidirectional and over the area where the trucks are bolted to prevent the board cracking between the strands of glass on impact (when the board lands, the resulting impact results in the trucks being forced up through the board and this force is transferred to the topside of the board which can result in splitting). Suitably these pieces would be rectangular in shape and 90 mm wide and 110 mm long. Finally a layer of unidirectional R-glass would be provided on top and of a size and shape to cover the topside of the skateboard deck. Suitably this layer would be rectangular in shape with rounded ends and have a width at the tail end of 170 mm, a width at the front end of 178 mm and a length of 783 mm. Strips of 200 gram biaxial E glass woven tape (50 mm wide, manufactured by Colan Sydney and available from Fibreglass International Pty Ltd) could be provided along each side and each end of the bottom layer so as to provide strength for the outer edge and perimeter of the skateboard deck. Four rectangular strips of biaxial E-glass could be provided down each side of the bottom layer (eight strips in total), each strip suitably being 50 mm wide and 72 cm long. Six rectangular strips 10 mm long of 50 mm woven tape could also provided around each end of bottom layer within the semicircular region and in a fan style pattern such that the strips overlap each other and the side strips similarly to skateboard deck 1. A further six rectangular strips similarly to skateboard deck 1 could also provided longitudinally on each end of bottom layer 2 all of which overlap. The total number of strips 14 at each end of this board being twelve (twenty-four in total). At least one aligned slot in the core and at least the adjacent unidirectional layers would be provided so as to accommodate at least one tie member. Preferably two slots would be provided at the kick areas of the board.

It will be appreciated that the present invention can be embodied in other forms. For example, the composite of the invention is not limited to use as a skateboard deck but could also be used in snowboards, waterskis, wakeskates, skimboards, sandboards and skis.

1. A composite board including:
a core having upper and lower surfaces and at least one aperture extending therebetween,
at least one upper reinforcing layer disposed on the upper surface of the core and at least one lower reinforcing layer disposed on the lower surface of the core, the upper and lower reinforcing layers each including at least one aperture extending therethrough, the apertures in the upper and lower reinforcing layers being in substantial alignment with each other and with the aperture or apertures in the core,
at least one tie member passing through the substantially aligned apertures, each said tie member having a first end portion protruding through said aligned apertures from said upper reinforcing layer and a second end portion protruding through said aligned apertures from said lower reinforcing layer, said first and second end portions being secured to a surface of said respective layers.

2. A composite board according to claim 1 wherein an additional reinforcing layer is provided on the upper and lower reinforcing layers.

3. A composite board according to claim 2, wherein the additional reinforcing layers are each provided with at least one aligned aperture for accommodating the at least one tie member.

4. A composite board according to claim 1 wherein each of said at least one tie member is formed from triaxial E-glass.

5. A composite board according to claim 1 wherein a pair of tie members is provided in said aligned aperture or apertures.

6. A composite board according to claim 1 wherein the core is made from foam.

7. A composite board according to claim 1 wherein the board is impregnated with resin.

8. A composite board according to claim 1 wherein each reinforcing layer is biaxial or unidirectional.

10. A composite board according to claim 1 wherein each reinforcing layer is formed from fibreglass.

11. A composite board according to claim 10 wherein each reinforcing layer is formed from E-glass, R-glass, Te-glass or S-glass.

12. A composite board according to claim 1 wherein each reinforcing layer is formed from carbon.

13. A composite board according to claim 1 wherein two or more reinforcing layers are provided on either side of the core, one layer being unidirectional and the other layer being biaxial.

14. A composite board according to claim 13 wherein a first reinforcing layer adjacent the core is formed from biaxial E-glass and a second layer adjacent the first layer is formed from unidirectional R-glass.

15. A skateboard having
a deck formed from the composite board according to claim 1.

16. A process for preparing a composite board including
placing into a mold a core having upper and lower surfaces and at least one aperture extending therebetween, positioning at least one upper reinforcing layer on the upper surface of the core and at least one lower reinforcing layer on the lower surface of the core, the upper and lower reinforcing layers each including at least one aperture extending therethrough, the apertures in the upper and lower reinforcing layers being in substantial alignment with each other and with the aperture or apertures in the core, passing at least one tie member through the substantially aligned apertures, each said tie member having a first end portion protruding through said aligned apertures from said upper reinforcing layer and a second end portion protruding through said aligned apertures from said lower reinforcing layer, and securing said first and second end portions to a surface of said upper and lower layers, respectively;
filling the mold with resin and
allowing the resin to cure.
